(19) United States
(12) Patent Application Publication
(10) Pub. No.: US 2018/0283078 A1
(43) Pub. Date: Oct. 4, 2018

(54) MOTORIZED DOOR HINGE SYSTEM AND METHOD

(71) Applicant: Erosh Damboragama, Mississauga (CA)

(72) Inventor: Erosh Damboragama, Mississauga (CA)

(21) Appl. No.: 15/471,917

(22) Filed: Mar. 28, 2017

(51) Int. Cl. E05F 15/72; E05D 11/04; E05D 3/02; E05F 15/611; E05D 7/00; E05F 15/77

(52) U.S. Cl. CPC E05F 15/72; E05D 11/04; E05D 3/02; E05Y 2900/134; E05D 7/00; E05F 15/77; E05F 15/611

(57) ABSTRACT

A motorized door hinge system includes a door hinge, a mechanical manipulator assembly, and a plurality of bearings. The motorized door hinge system is useful for mechanically closing and opening a door through a fire detection device being activate or a software application.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of door hinges and more specifically relates to a motorized door hinge.

### 2. Description of Related Art

A hinge is a mechanical bearing that connects two solid objects, typically allowing only a limited angle of rotation between them. Two objects connected by an ideal hinge rotate relative to each other about a fixed axis of rotation. A hinge may be mounted to a door frame allowing the door to open and close access to an area.

A relay is an electrically operated switch. Many relays use an electromagnet to mechanically operate a switch, but other operating principles are also used, such as solid-state relays. Relays are used where it is necessary to control a circuit by a separate low-power signal, or where several circuits must be controlled by one signal.

Software applications can be used to display, generate, and communicate electronic communications. Software applications are designed for use on a mobile computing device, such as a smartphone device. By interacting with a user interface on a mobile computing device, a user of the mobile application may interact with various features of the mobile application.

U.S. Pat. No. 5,070,442 to Ann T. Syron-Townson, et al. relates to a computerized door locking and monitoring system using power-line carrier components. The described computerized door locking and monitoring system using power-line carrier components includes a method of locking, unlocking and monitoring doors using a computer and a computer software program, electro-locking devices, power-line carrier components and existing AC wiring from the door sites to the computer. The computer program changes the status of each door according to predetermined schedule and displays the locked/unlocked/ajar status of each door as well as the event change (Push bar/key/fire alarm). Exits are fitted with electro-door locks with sensor capabilities and are monitored from the computer via power line carrier components. At each exit site, a receiver receives commands from the computer and changes the locking status while a transmitter at the door site reports every changed status back to the computer. A microprocessor at each door site can control the doors and operate via battery back-up in a power failure or when communication from the computer program is interrupted. A transmitter at the fire alarm panel causes all doors to unlock if the fire alarm is activated.

### BRIEF SUMMARY OF THE INVENTION

In view of the foregoing disadvantages inherent in the known door hinge(s) art, the present disclosure provides a novel motorized door hinge system and method. The general purpose of the present disclosure, which will be described subsequently in greater detail, is to provide the motorized door hinge system and method for convenient use in manipulating doors remotely.

A motorized door hinge system is disclosed herein. The motorized door hinge system includes a door hinge having a left-hinge plate and a right-hinge plate that are linearly coupled with a pin along their respective length. The door hinge as an assembly as able to be affixed to a door that opens and closes to allow ingress and egress.

A mechanical manipulator assembly may be coupled to the pin by a rotator. The mechanical manipulator assembly may include a motor having a transceiver able to receive wireless signals from a remote device (such as a smartphone or other electronic device) to actuate the rotator to close or open the door, and send notifications to the remote device. The mechanical manipulator assembly may further include a high voltage relay connected to a fire detection device, and an external wiring connection assembly from the motor to the high voltage relay that may have a signal activating mechanism that may be activated when an electrical charge from the high voltage relay is interrupted. The signal activating mechanism may be configured to actuate the rotator to move the left-hinge plate for closing the door. Wired and wireless means may be employed.

Furthermore, the motorized door hinge system may include a plurality of bearings coupled to the pin and may be configured to enable the pin to rotate with a minimum of friction. Each of the bearings may have an outer ring, an inner ring, and a plurality of spherical balls within an exterior ring. Other friction reducing means may be used.

According to another embodiment, a method of using the motorized door hinge system is also disclosed herein. The method of using the motorized door hinge system includes detecting a signal from the fire detection device that moves the rotator in a clock-wise rotation to close the door. Optionally, steps two and three may include activating the mechanical manipulator assembly via the transceiver with the remote device that moves the rotator in a counter clock-wise rotation to open the door, and activating the mechanical manipulator assembly via the transceiver with the remote device that moves the rotator in a clock-wise rotation to close the door. The relative movements mentioned may be changed as per application of door swing direction (left to right or right to left or up and down).

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a motorized door hinge system and method, constructed and operative according to the teachings of the present disclosure.

FIG. 1 is a perspective view of the motorized door hinge system during an ‘in-use’ condition, according to an embodiment of the disclosure.

FIG. 2 is a front perspective view of the motorized door hinge system of FIG. 1, according to an embodiment of the present disclosure.

FIG. 3 is a wiring diagram of the motorized door hinge system of FIG. 1, according to an embodiment of the present disclosure.

FIG. 4 is a front perspective view of a plurality of bearings used in the motorized door hinge system of FIG. 1, according to an embodiment of the present disclosure.

FIG. 5 is a flow diagram illustrating a method of using the motorized door hinge system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to door hinges and more particularly to a motorized door hinge system and method as used to improve the safety of monitoring and enabling the functions of a door.

Generally, fires create damage to buildings before the fire is able to be extinguished. By closing the door mechanically and without being nearby the fire, may save in cost and promote safety. Furthermore, it may be convenient to open or close a door while being anywhere in the world through use of a simple mobile application which the present invention serves to provide.

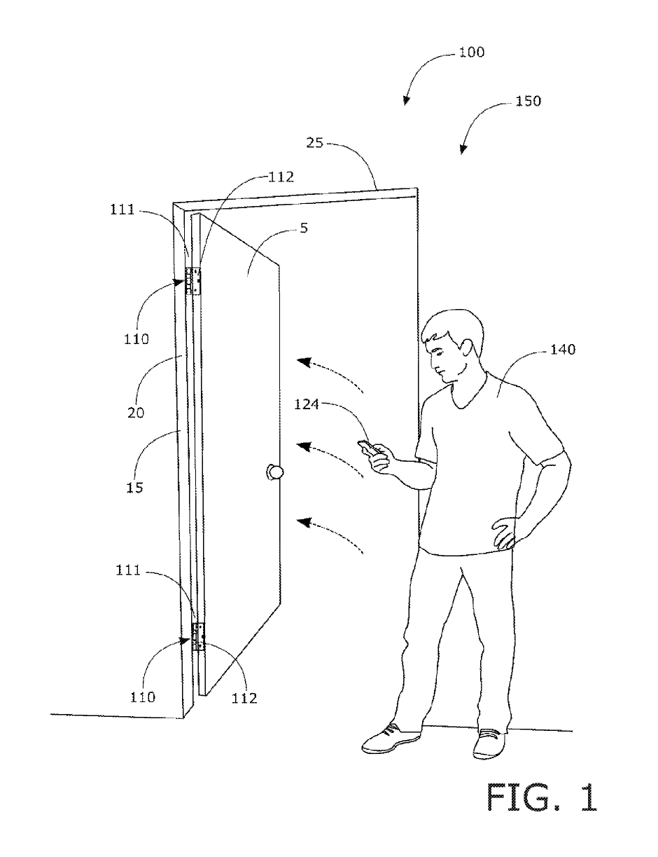

Referring now more specifically to the drawings by numerals of reference, there is shown in FIGS. 1-4, various views of a motorized door hinge system 100. FIG. 1 shows a motorized door hinge system 100 during an ‘in-use’ condition 150, according to an embodiment of the present disclosure. Here, the motorized door hinge system 100 may be beneficial for use by a user 140 to monitor and enact the functions of closing and opening a door 5. As illustrated, the motorized door hinge system 100 may include a door hinge 110 having a left-hinge plate 111 and a right-hinge plate 112 that are linearly coupled with a pin 113 along their respective length. The door hinge 110 as an assembly may be able to be affixed to the door 5 that opens and closes.

A mechanical manipulator assembly 120 may be coupled to the pin 113 by a rotator 122. The mechanical manipulator assembly 120 may include a motor 121 having a transceiver 123 able to receive wireless signals from a remote device 124 to actuate the rotator 122 to close or open the door 5, and send notifications to the remote device 124. In preferred embodiments rotator 122 comprises a threaded gear that is mated to threadingly turn in relation to a pin 113 or the like. The mechanical manipulator assembly 120 may further include a high voltage relay 130 connected to a fire detection device 131, and an external wiring connection assembly 135 from the motor to the high voltage relay 130 that may have a signal activating mechanism 137 that may be activated when an electrical charge from the high voltage relay 130 is interrupted. The signal activating mechanism 130 may be configured to actuate the rotator 122 to move the left-hinge plate 111 for closing the door 5.

Furthermore, the motorized door hinge system 100 may include a plurality of bearings 138 coupled to the pin 113 and may be configured to enable the pin 113 to rotate with a minimum of friction. Each of the bearings 138 may have an outer ring 142, an inner ring 144, and a plurality of spherical balls 146 within an exterior ring 147.

According to one embodiment, the motorized door hinge system 100 may be arranged as a kit 105. In particular, the motorized door hinge system 100 may further include a set of instructions 155. The instructions 155 may detail functional relationships in relation to the structure of the motorized door hinge system 100 (such that the motorized door hinge system 100 can be installed, used, maintained, or the like, in a preferred manner).

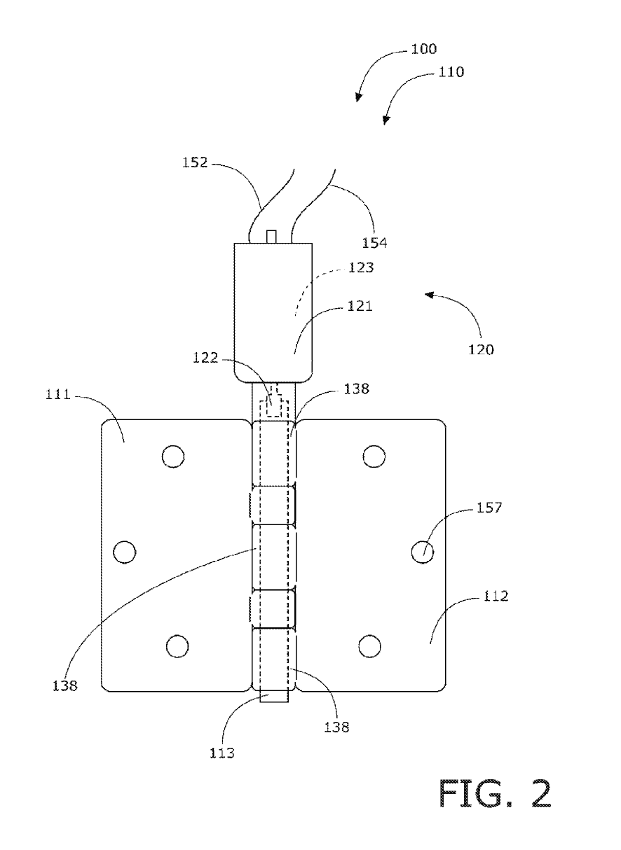

FIG. 2 shows the motorized door hinge system 100 of FIG. 1, according to an embodiment of the present disclosure. As above, the motorized door hinge system 100 may include the door hinge 110 having the left-hinge plate 111 and the right-hinge plate 112 that are linearly coupled with the pin 113 along their respective length. The door hinge 110 as the assembly may be able to be affixed to the door 5 that opens and closes. The right-hinge plate 112 or the left-hinge plate 111 may attach to the door 5 and the other right-hinge plate 112 or left-hinge plate 111 not attached to the door may attach to an outer surface 25 of a door jamb 20 on a door-structure 15. A plurality of screws 157 may be utilized for fixedly attaching the left-hinge plate 111 and the right-hinge plate 112 to the door structure 15 such that the pin 113 may be able to maintain a vertical positioning. Other fastening devices other than the plurality of screws 157 may be utilized. The motor 121 mentioned above may be coupled adjacent to the top of the door hinge 110 on the outer surface 25.

The mechanical manipulator 25 assembly may be coupled to the pin 113 by the rotator 122. The rotator 122 may comprise a threaded gear 122. The threaded gear 122 may be operated via the motor 121 to cause the door 5 to close. Furthermore, the threaded gear 122 may be able to move in a clock-wise-rotation to shut the door 5 and a counter clock-wise-rotation to open the door 5.

The mechanical manipulator assembly 120 may also include the motor 121 having the transceiver 123 able to receive wireless signals from the remote device 124 to actuate the rotator 122 to close or open the door 5, and send notifications to the remote device 124. The door 5 may be caused to open and alternately close by a user-command through the signal 159 received via the transceiver 123; the signal 159 may be sent from the remote device 124. Notifications may be sent to the remote device 124 via the transceiver 123 when an activation by the signal 159 occurs. These notifications that may be sent to the remote device 124 via the transceiver 123 occur when the door 5 opens and closes. The remote device 124 may be a mobile device (i.e. smart phone, tablet, PDA, etc.). The remote device 124 may be communicatively connected to the transceiver 123 via a software application. The software application may be downloaded onto any of the remote devices 124.

The mechanical manipulator assembly 120 may further include the high voltage relay 130 connected to the fire detection device 131, and the external wiring connection 135 assembly from the motor 121 to the high voltage relay 130 that may have the signal activating mechanism 137 which may be activated when the electrical charge from the high voltage relay 130 is interrupted. The signal activating mechanism 137 may be configured to actuate the rotator 122 to move the left-hinge plate 111 for closing the door 5.

The motorized door hinge system 100 may include the plurality of bearings 138 coupled to the pin 113 and may be configured to enable the pin 113 to rotate with a minimum of friction. Each of the bearings 138 may have the outer ring 142, the inner ring 144, and the plurality of spherical balls 146 within the exterior ring 147. Other friction reducing means may be used.

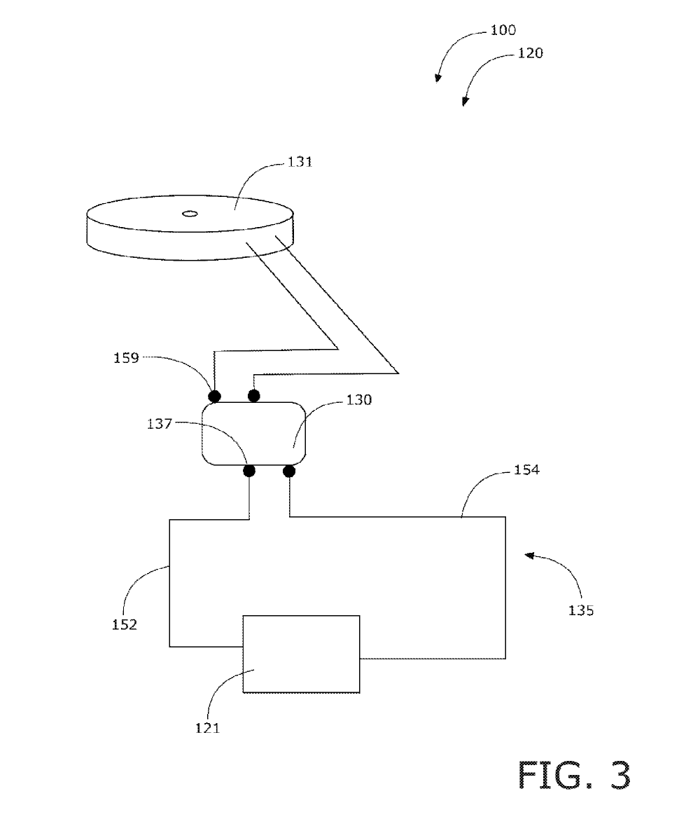

FIG. 3 is a wiring diagram of the motorized door hinge system 100 of FIG. 1, according to an embodiment of the present disclosure. The wiring diagram may illustrate the mechanical manipulator assembly 120 having the high voltage relay 130 connected to the fire detection device 131. The door 5 may close when the signal 159 is received via the relay 130. The signal 159 may be sent from the fire detection device 131. Fire detection devices 131 may include smoke alarms. The external wiring connection assembly 135 connects from the motor 121 to the high voltage relay 130, and may include the signal activating mechanism 137 that may be activated when the electrical charge from the high voltage relay 130 is interrupted. The signal activating mechanism 137 may be configured to actuate the rotator 122 to move the left-hinge plate 111 for closing the door 5. Furthermore, the external wiring connection assembly 135 may include a positive electrical current wire 152 and a negative electrical current wire 154 connecting from the motor 121 to the relay 130. An external power source (not shown) utilizing direct current (DC) may supply power to the mechanical manipulator assembly 120.

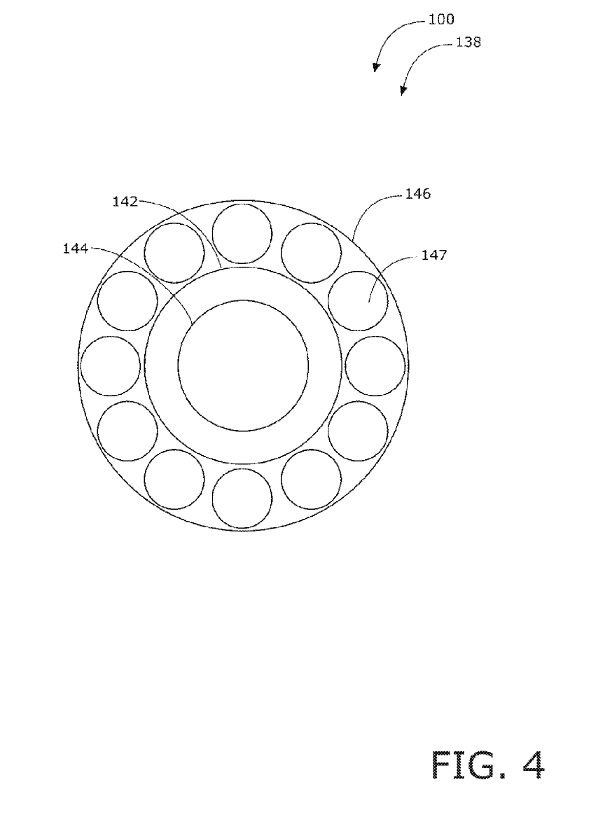

FIG. 4 is a front perspective view of the motorized door hinge system 100 of FIG. 1, according to an embodiment of the present disclosure. The plurality of bearings 138 included in the motorized door hinge system 100, may be coupled to the pin 113, and may be configured to enable the pin 113 to rotate with the minimum of friction. Each of the bearings 138 may have the outer ring 142, the inner ring 144, and the plurality of spherical balls 146 within the exterior ring 147. The plurality of bearings 138 may comprise of ball bearings, however, other bearings having the same functionality may be utilized.

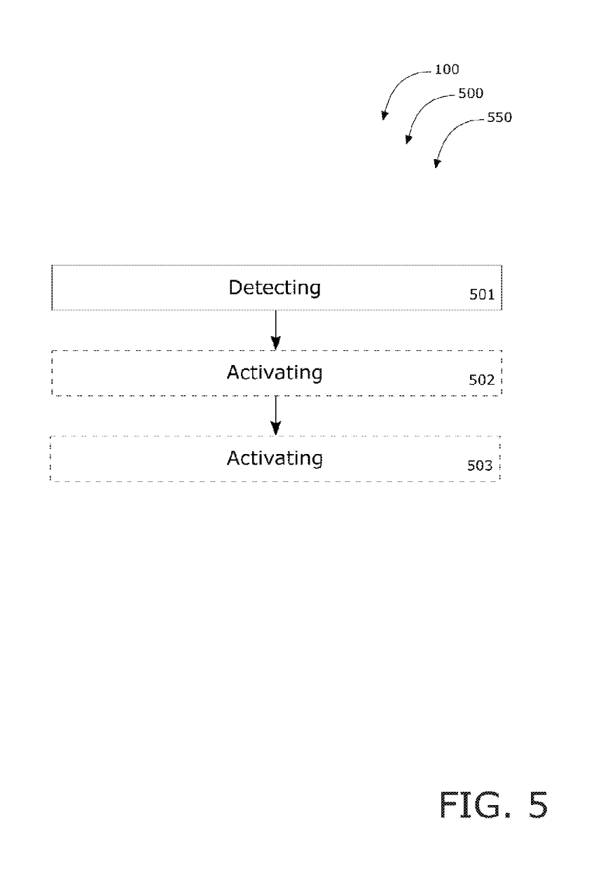

FIG. 5 is a flow diagram illustrating a method of use 500 for using the motorized door hinge system 100, according to an embodiment of the present disclosure. In particular, the method for using 500 the motorized door hinge system 100 may include one or more components or features of the motorized door hinge system 100 as described above. As illustrated, the method for using 500 the motorized door hinge system 100 may include the steps of: step one 501, detecting the signal 159 from the fire detection device 131 that moves the rotator 122 in a clock-wise rotation to close the door 5; step two 502, activating the mechanical manipulator assembly 120 via the transceiver 123 with the remote device 124 that moves the rotator 122 in a counter clock-wise rotation to open the door 5; and step three 503, activating the mechanical manipulator assembly 120 via the transceiver 123 with the remote device 124 that moves the rotator 122 in a clock-wise rotation to close the door 5.

It should be noted that steps two 502 and three 503 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the motorized door hinge system e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A motorized door hinge system comprising:
a door hinge having a left-hinge plate and a right-hinge plate that are linearly coupled with a pin along their respective length, said door hinge as an assembly able to be affixed to a door that opens and closes;
a mechanical manipulator assembly coupled to the pin by a rotator, the mechanical manipulator assembly including;
a motor having a transceiver able to receive wireless signals from a remote device to actuate the rotator to close or open the door, and send notifications to said remote device,
a high voltage relay connected to a fire detection device,
an external wiring connection assembly from the motor to the high voltage relay having a signal activating mechanism that is activated when an electrical charge from the high voltage relay is interrupted, the signal activating mechanism configured to actuate the rotator to move the left-hinge plate for closing the door; and
a plurality of bearings coupled to the pin and configured to enable the pin to rotate with a minimum of friction, each said bearing having an outer ring, an inner ring, and a plurality of spherical balls within an exterior ring.

2. The motorized door hinge system of claim 1, wherein said rotator comprises a threaded gear.

3. The motorized door hinge system of claim 2, wherein said threaded gear is operated via said motor to cause said door to close.

4. The motorized door hinge system of claim 3, wherein said threaded gear is able to move in a clock-wise-rotation to shut said door and a counter clock-wise-rotation to open said door.

5. The motorized door hinge system of claim 4, wherein said door is caused to close caused by a signal received via said relay, said signal sent from said fire detection device.

6. The motorized door hinge system of claim 5, wherein said door is caused to open and alternately close by a user-command through said signal received via the transceiver, said signal sent from the remote device.

7. The motorized door hinge system of claim 6, wherein notifications are sent to the remote device via the transceiver when an activation by said signal occurs.

8. The motorized door hinge system of claim 7, wherein said notifications are sent to the remote device via the transceiver when said door opens and closes.

9. The motorized door hinge system of claim 8, wherein said remote device is a mobile device.

10. The motorized door hinge system of claim 9, wherein said remote device is communicatively connected to said transceiver via a software application.

11. The motorized door hinge system of claim 1, wherein an external power source utilizing direct current (DC) supplies power to said mechanical manipulator assembly.

12. The motorized door hinge system of claim 1, wherein said external wiring connection assembly includes a positive electrical current wire and a negative electrical current wire connecting from said motor to said relay.

13. The motorized door hinge system of claim 1, wherein said plurality of bearings comprises of ball bearings.

14. The motorized door hinge system of claim 1, wherein a plurality of screws are utilized for fixedly attaching the left-hinge plate and the right-hinge plate to a door structure such that the pin is able to maintain a vertical positioning.

15. The motorized door hinge system of claim 14, wherein said right-hinge plate or said left-hinge plate attaches to said door and other said right-hinge plate or said left-hinge plate not attached to said door attaches to an outer surface of a door jamb on said door-structure.

16. The motorized door hinge system of claim 15, wherein said motor is coupled adjacent to the top of the door hinge on said outer surface.

17. A motorized door hinge system, the motorized door hinge system comprising:
a door hinge having a left-hinge plate and a right-hinge plate that are linearly coupled with a pin along their respective length, said door hinge as an assembly able to be affixed to a door that opens and closes;
a mechanical manipulator assembly coupled to the pin by a rotator, the mechanical manipulator assembly including;
a motor having a transceiver able to receive wireless signals from a remote device to actuate the rotator to close or open the door, and send notifications to said remote device,
a high voltage relay connected to a fire detection device, and
an external wiring connection assembly from the motor to the high voltage relay having a signal activating mechanism that is activated when an electrical charge from the high voltage relay is interrupted, the signal activating mechanism configured to actuate the rotator to move the left-hinge plate for closing the door;
a plurality of bearings coupled to the pin and configured to enable the pin to rotate with a minimum of friction, each said bearing having an outer ring, an inner ring, and a plurality of spherical balls within an exterior ring;
wherein said rotator comprises a threaded gear;
wherein said threaded gear is operated via said motor to cause said door to close;
wherein said threaded gear is able to move in a clock-wise-rotation to shut said door and a counter clock-wise-rotation to open said door;
wherein said door is caused to close caused by a signal received via said relay, said signal sent from said fire detection device;
wherein said door is caused to open and alternately close by a user-command through said signal received via the transceiver, said signal sent from the remote device;
wherein notifications are sent to the remote device via the transceiver when an activation by said signal occurs;
wherein said notifications are sent to the remote device via the transceiver when said door opens and closes;
wherein said remote device is a mobile device;
wherein said remote device is communicatively connected to said transceiver via a software application;
wherein an external power source utilizing direct current (DC) supplies power to said mechanical manipulator assembly;
wherein said external wiring connection assembly includes a positive electrical current wire and a negative electrical current wire connecting from said motor to said relay;
wherein said plurality of bearings comprises of ball bearings;
wherein a plurality of screws are utilized for fixedly attaching the left-hinge plate and the right-hinge plate to a door structure such that the pin is able to maintain a vertical positioning;
wherein said right-hinge plate or said left-hinge plate attaches to said door and other said right-hinge plate or said left-hinge plate not attached to said door attaches to an outer surface of a door jamb on said door-structure; and
wherein said motor is coupled adjacent to the top of the door hinge on said outer surface.

18. The motorized door hinge system of claim 17, further comprising set of instructions; and
wherein the motorized door hinge system is arranged as a kit.

19. A method of using a motorized door hinge system, the method comprising the step of:
detecting a signal from a fire detection device that moves a rotator in a clock-wise rotation to close the door.

20. The method of claim 19, further comprising the steps of:
activating an mechanical manipulator assembly via a transceiver with a remote device that moves the rotator in a counter clock-wise rotation to open the door, and
activating said mechanical manipulator assembly via said transceiver with said remote device that moves said rotator in a clock-wise rotation to close said door.
